(19) United States
(12) Patent Application Publication
(10) Pub. No.: US 2011/0258017 A1
(43) Pub. Date: Oct. 20, 2011

(54) INTERPRETATION OF A TRENDING TERM TO DEVELOP A MEDIA CONTENT CHANNEL

(75) Inventors: Patrick Ratnakanth Koppula, San Francisco, CA (US); Greg Roberts, Napa, CA (US); Nick Roberts, San Francisco, CA (US); John Rehling, San Francisco, CA (US)

(73) Assignee: FFWD CORPORATION, San Francisco, CA (US)

(21) Appl. No.: 12/760,574

(22) Filed: Apr. 15, 2010

(51) Int. Cl. G06Q 10/00

(52) U.S. Cl. 705/7.29

(57) ABSTRACT

Methods and systems of interpretation of a trending term to develop a media content channel are disclosed. In one embodiment, a method includes interpreting a trending term to identify an association parameter when the trending term is received. In addition, the method also includes algorithmically determining a media attribute associated with the trending term using a computer process. The method also includes updating a channel with a related media content comprised of the media attribute. The media attribute may include a metadata, a visual data and/or an audio data. The trending term may be interpreted using an internal capturing and/or an external capturing when the trending term is received. The method may also include displaying the channel to a viewer using a cable transmission, a network, a wireless transmission, and/or a local storage medium.

### FIELD OF TECHNOLOGY

This disclosure relates generally to methods and systems of interpretation of a trending term to develop a media content channel.

### BACKGROUND

Media such as videos, music, and text may be selected and categorized based on a subjective impression that the selected media is related and/or may be of interest to a viewer. The subjective impression may fail to correlate to an interest of a viewer, and the viewer may disagree with the choices of media based on the subjective impression. In addition, the subjective impression used to select and/or categorize the media may require a human being to review and/or analyze the media with respect to a target audience, which may require substantial investment of resources such as time, expense, and/or effort.

The investment required to generate the subjective impression to select and/or categorize media may therefore limit the number of channels developed to present the selected and/or categorized media. Furthermore, the subjective impression may result in a programming content of media and/or channels that fail to appeal to the interest of the viewer. Accordingly, the viewer may be dissatisfied with the choices presented, and may seek media from other sources. As a result, a potential revenue based on the interest of the viewer be lost, and viewer may fail to discover media that would be of interest.

### SUMMARY

Methods and systems of interpretation of a trending term to develop a media content channel are disclosed. In one aspect, the method includes interpreting a trending term to identify an association parameter when the trending term is received. In addition, the method includes algorithmically determining a media attribute associated with the trending term using a computer process. The method also includes updating a channel with a related media content comprised of the media attribute.

The media attribute may include a metadata, a visual data and/or an audio data. The trending term may be interpreted using an internal capturing and/or an external capturing when the trending term is received. The method may also include displaying the channel to a viewer using a cable transmission, a network, a wireless transmission, and/or a local storage medium. The method may also include acquiring the related media content of the channel based on a viewer access of the channel and a sequence of the channel. The above mentioned related media content may be acquired from an online media source, a cable source, a network storage and/or a local storage.

The method may also preserve the channel based on a persistence of a viewer's interest. The method may use a statistical relationship between the related media content and an audience that affects the algorithm used to determine the media attribute. The method may use an association between at least two individuals that affects the algorithm used to determine the media attribute.

The method may further include automatically identifying the trending term based on an online source. The trending term may be identified using an electronically converted audio, a precreated feed, a blog, a micro-blog, a news site, an online reference, an email, an IM, a text message, a social networking site, a community based news article, and/or a media content provider.

In another aspect, the system includes a server that uses a processor and a memory. In addition, the system includes an identification module of the server to automatically identify the trending term using the processor and the memory. The system also includes an interpretation module to interpret the trending term to identify an association parameter. The system further includes an association module of the server that algorithmically determines a media attribute associated with the trending term when the trending term has been identified. The system includes a channel to be updated using a related media content comprised of the media attribute. The system also includes an acquisition module to acquire the related media content when a request to form the channel is received.

The trending term may be identified using electronically converted audio, the precreated feed, the blog, the micro-blog, the news site, the online reference, the email, the IM, the text message, the review site, the social networking site, the community based news article site, and the media content provider. The media attribute may be comprised of the metadata, the visual data and/or the audio data. The trending term may be interpreted using internal capturing and/or external capturing when the trending term is received.

The system may further include a display module to display the channel to a viewer using a website, a cable transmission, a network transmission, a wireless transmission and/or a local storage. The system may include acquiring the related media content of the channel based on a viewer access of the channel and a sequence of the channel. The system may acquire the related media content from an online source, a cable source, a network storage, and/or a local storage medium.

In yet another aspect, the method includes automatically identifying the trending term based on an online source. In addition, the method includes interpreting the trending term to identify an association parameter. The method further includes algorithmically determining a media attribute associated with the trending term using a computer process. The trending term may be identified using a communication that includes one or more of the electronically converted audio, the precreated feed, the blog, the micro-blog, the news site, the online reference, the email, the IM, the text message, the review site, the social networking site, and/or the media content provider.

The method further includes updating an online channel that includes related media content. The method also includes acquiring the related media content that includes the media attribute when a request to form a channel is received. The media attribute may include one or more of a metadata, a visual data, and/or an audio data. The portion of the algorithm that determines a media attribute associated with the trending term may interpret the trending term using at least one of internal capturing and/or external capturing.

The methods and systems disclosed herein may be implemented in any means for achieving various aspects, and may be executed in a form of a machine readable medium embodying a set of instructions that, when executed by a machine, cause the machine to perform any of the operations disclosed herein. Other aspects and example embodiments are provided in the drawings and the detailed description that follows.

### BRIEF DESCRIPTION OF THE VIEWS OF DRAWINGS

Example embodiments are illustrated by way of example and not limitation in the figures of the accompanying drawings, in which like references indicate similar elements and in which:

FIG. 1 illustrates a channel creation module providing a created channel to a viewer, according to one embodiment.

FIGS. 2A-D are an illustration of a channel generation and feedback sequence, according to one embodiment.

FIG. 3 is an exploded view of the channel creation module, according to one embodiment.

FIGS. 4A-E illustrate operations of various modules of the channel creation module to configure a channel, according to one embodiment.

FIG. 5 is an exploded view of the sources of content, according to one embodiment.

FIG. 6 is a table view illustrating sources of content, trending terms, and associated information, according to one embodiment.

FIG. 7 is a user interface view illustrating a display of a customized channel, according to one embodiment.

FIG. 8 is a diagrammatic system view of a data processing system in which any of the embodiments disclosed herein may be performed, according to one embodiment.

FIG. 9 is a process flow chart that illustrates the creation of a customized channel, according to one embodiment.

FIG. 10 is a process flow of updating the channel with the acquired media content, according to one embodiment.

Other features of the present embodiments will be apparent from the accompanying drawings and from the detailed description that follows.

### DETAILED DESCRIPTION

Methods and systems of interpretation of a trending term to develop a media content channel are disclosed. Although the present embodiments have been described with reference to specific example embodiments, it will be evident that various modifications and changes may be made to these embodiments without departing from the broader spirit and scope of the various embodiments.

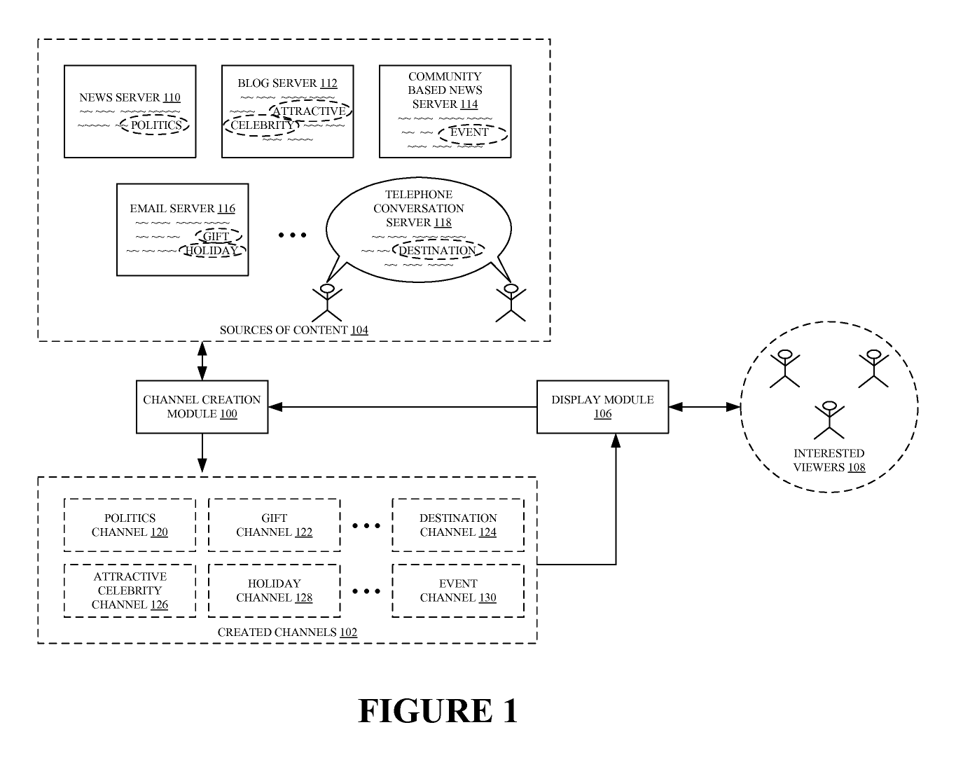

FIG. 1 illustrates a channel creation module providing a created channel to a viewer, according to one embodiment. In particular, FIG. 1 illustrates a channel creation module 100, created channels 102, sources of content 104, display module 106, interested viewers 108, news server 110, a blog server 112, a community based news article server 114, email server 116, telephone conversation server 118, a politics channel 120, a gift channel 122, a destination channel 124, an attractive celebrity channel 126, a holiday channel 128, and an event channel 130, according to one embodiment.

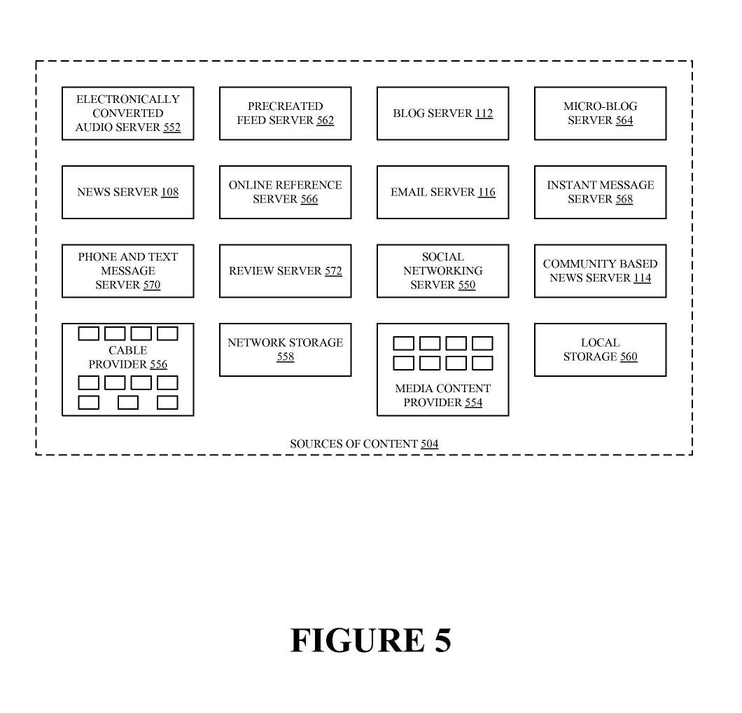

The channel creation module 100 may search various sources of content 104 (e.g., the community based news server 110, the blog server 116, etc.) for a trending term 474 of FIG. 5A-E (e.g., popular and/or frequently appearing terms occurring in news, popular media, discussions, etc.) The trending term 474 may be used by the channel creation module 100 to generate created channels 102.

Each of the created channels 102 may be displayed to a group of interested viewers 108 via display module 106. The interaction of the interested viewers and the responses to the presented channels may be relayed to the channel creation module 100. The channel creation module 100 may in turn modify the sequence and content of the created channels 102 to improve the interested viewers' 108 response to the presented channels. The channel creation module 100 may also interact directly with the content presented to the interested viewers 108 through the display module 106, such as organizing the format of the channels presented, seeking direct feedback through questions and programming options, and by providing questions to viewers in areas outside of the display of the created channels 102.

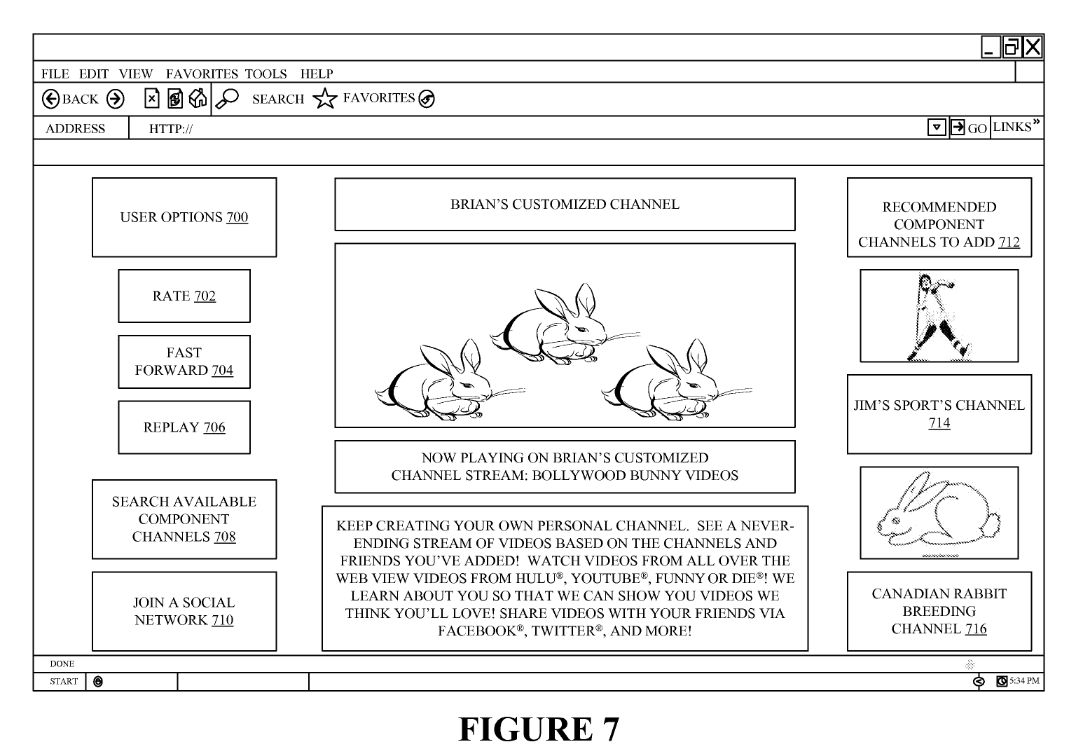

Each communicative coupling between the sources of content 104, the channel creation module 100, the created channels 102, the display module 106, and/or the interested viewers 108 may occur through a network 185 (e.g., illustrated in FIG. 7) and/or a direct connection. The network 185 may be a LAN, a WAN, or any other form of network. In other embodiments, channel creation module 100, the display module 106, the created channels 102, the sources of content 104, and the interested viewers 108 may be communicatively coupled in other ways to allow customized channels to be presented to the interested viewers 108.

The created channels 102 may include a politics channel 120 based on a trending term 474 associated with political news, events, discussions, and people. The trending term 474 for the politics channel may be acquired from a news server 110 (e.g., CNN®, ABC®, FOX®, etc.). The created channels 102 may also include a gift channel 122 based on a discussion regarding gifts ideas for an upcoming holiday obtained from an email server 116. The gift channel 122 may include advertisements for the particular gift described, popular gifts for the holiday, videos showing programs related to particular gifts, etc.

The created channels may include a destination channel 124 based on a trending term obtained from a telephone conversation server 118. The telephone conversation server 118 may include a conversation and/or references to a particular destination. The destination channel 124 may include programs with similar destinations, and/or it may include upcoming events in the vicinity of the destination. The destination channel 124 may include programs illustrating activities in the area of the destination, and/or discounts for travel and lodging.

The created channels 118 may further include an attractive celebrity channel 126 based on a discussion regarding an attractive celebrity obtained by the channel creation module 100 on a blog server 112. The attractive celebrity channel 112 may include programs related to the particular celebrity described in the blog, and it may include programming related to other celebrities associated with the celebrity described in the blog server 112. The celebrity channel 112 may further include other programming determined to be of interest to a viewer 108 who may be interested in the celebrity, such as events that the celebrity recently attended or has been rumored to be attending.

The celebrity channel 112 may further include media related to fashion, entertainment news, and other associated content. The celebrity channel 112 may include information that is considered relevant for other reasons. For example, the celebrity channel 112 may include media content related to attractive people of a particular gender, fashion trends, design, and/or pets, regardless of whether the media content possesses a direct association with a particular celebrity. In other words, the celebrity channel may include information that is automatically determined to be tangentially related to a viewer's interest in a celebrity.

The created channels 118 may also include a holiday channel 128 to present programming related to an upcoming holiday, which may have been discussed in an email obtained from an email server 116. The created channels 118 may further include an event channel 130 that relates to an event described in content obtained from a community based news server (e.g., Yahoo Buzz®, Digg®, etc.). The event channel may also incorporate other media that is automatically determined to be related to the event and a viewer's interests even if it is only indirectly related to the event. Such information may include travel advertisements and/or activities available in the vicinity of an event, similar activities occurring in another location, and/or other persons who may be attending the event.

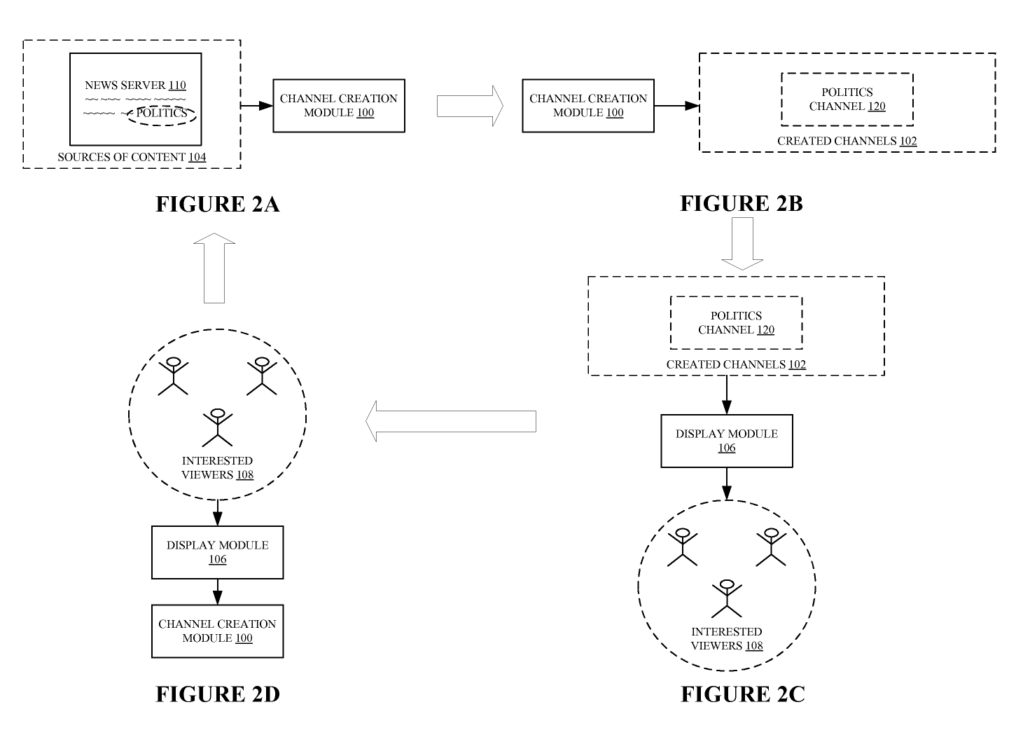

FIGS. 2A-D are an illustration of a channel generation and feedback sequence, according to one embodiment. In particular, FIG. 2 illustrates a channel creation module 100, created channels 102, sources of content 104, display module 106, interested viewers 108, news server 110, and politics channel 120, according to one embodiment.

FIG. 2A illustrates a trending term 474, “politics,” being identified and acquired by the channel creation module 100 from the sources of content 104. In the embodiment, “politics” is identified as a trending term from a news server (e.g., ABC, CBS, CNN, etc.). As illustrated, “politics” may represent a word, phrase, or sound bite associated with politics that may be described using a particular term.

FIG. 2B illustrates a created channel 102 formed based on the trending term 474 “politics,” according to one embodiment. As illustrated, the created channels 102 include the politics channel 120.

FIG. 2C illustrates the created channels 102, which includes the politics channel 120, being displayed to a set of interested viewers 108 via display module 106, according to one embodiment. The display module 106 may include computers, servers, mobile devices, televisions, portable media players, and other electronic devices. The number of interested viewers 108 may be a single person, and it may range up to an unlimited number of viewers.

FIG. 2D illustrates the interested viewers 108 communicating with the channel creation module 100 via display module 106 to relay a response to the created channels 102. The response may influence how the channel creation module 100 modifies and/or updates the created channels 102, including developing additional media content and/or channels.

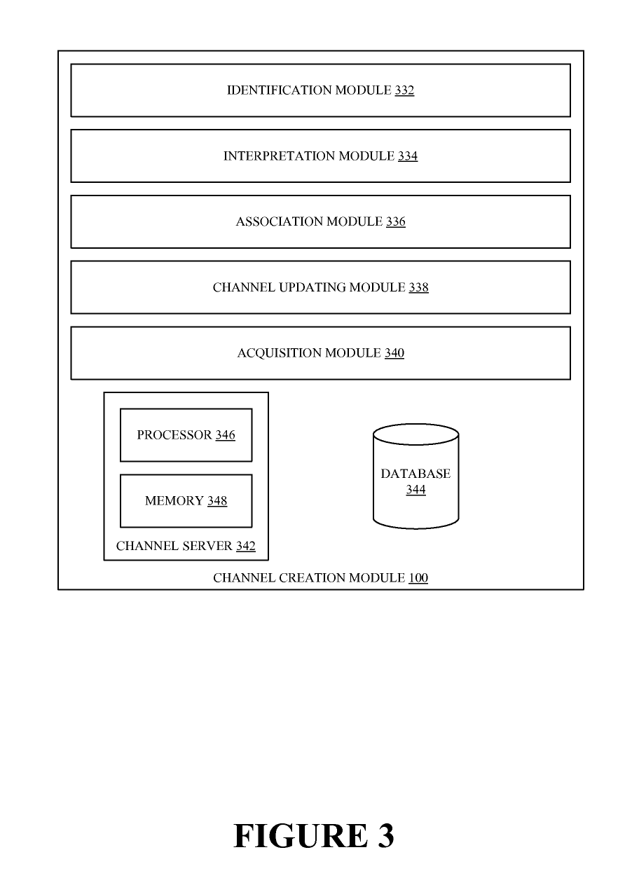

FIG. 3 is an exploded view of the channel creation module, according to one embodiment. In particular, FIG. 3 may include the channel creation module 100, an identification module 332, an interpretation module 334, an association module 336, a channel updating module 338, and an acquisition module 340. The channel creation module may also include the channel server 342 and the database 344. The channel server 342 may further include the processor 346 and the memory 348. Each of the modules and other components may be communicatively coupled to any of the other modules and components of the channel creation module 100.

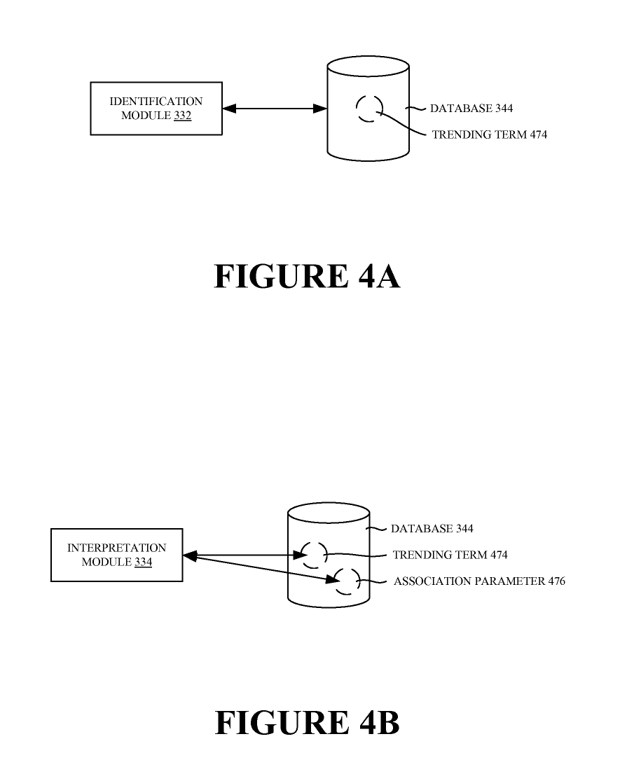

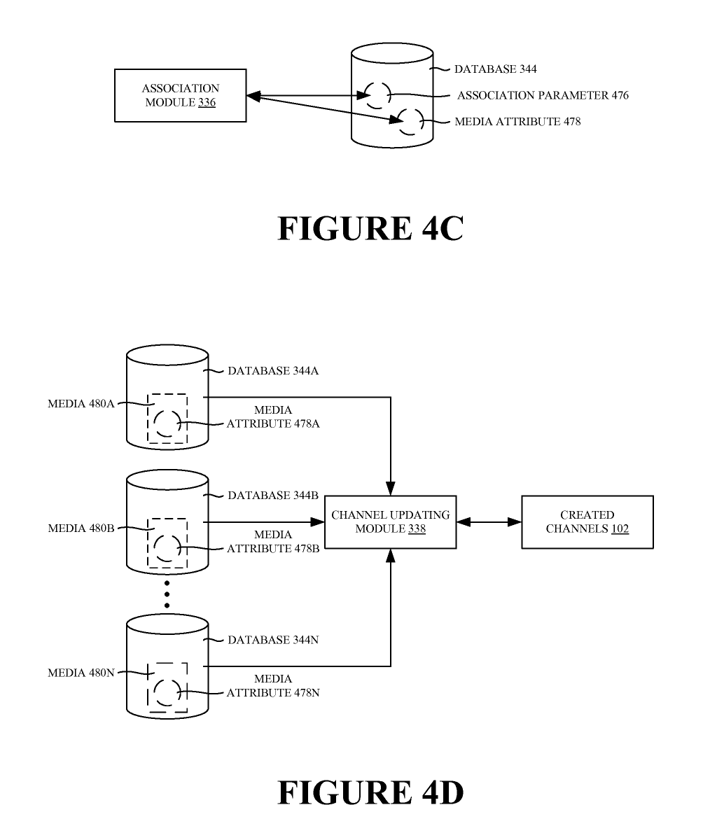

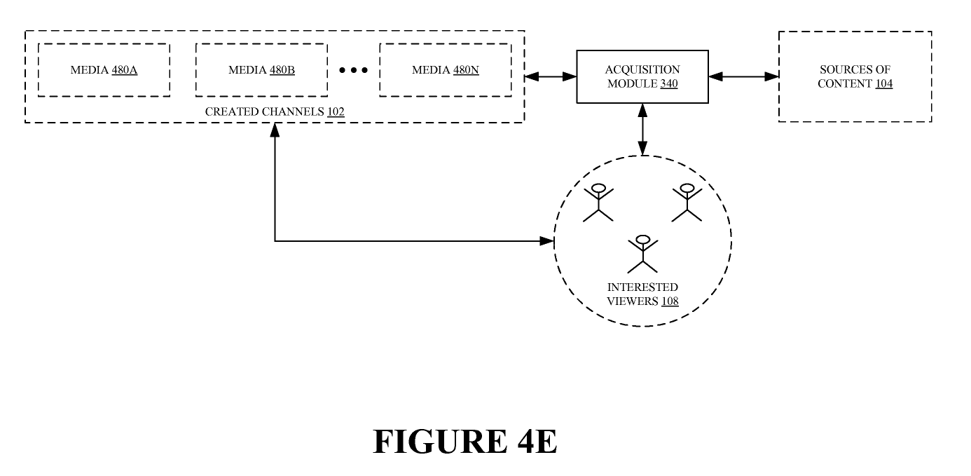

Not illustrated in FIG. 3 are a trending term 474, an association parameter 476, a media attribute 478, and a media 480, each of which may be stored on the database 344 according to one embodiment. The relationship of the components of the channel creation module 100 are further illustrated in FIGS. 4A-E, which show operations of various modules of the channel creation module to configure a channel, according to one embodiment.

FIGS. 4A-E include an identification module 330, a trending term 474, a database 344, an interpretation module 334, an association parameter 476, an association module 336, media attribute 478A-N, media 480A-N, a channel updating module 338, created channels 102, an acquisition module 340, sources of content 103, and interested viewers 108, according to one embodiment.

As illustrated in FIG. 4A, according to one embodiment, the identification module 132 of the channel creation module 100 may identify a trending term 474 (e.g., a descriptive term and/or phrase). The trending term 474 may be identified using one or more of an electronically converted audio, a precreated feed, a blog, a micro-blog, a news site, an online reference, an email, an IM, a text message, a review site, a social networking site, a community based news article site, and a media content provider. The trending term 474 may be stored on the database 344, which may include and/or communicate with the sources of content 104, as illustrated in FIG. 1. Additional potential sources of content are also illustrated in FIG. 5.

The selection of the trending term 474 may be based on a frequency of occurrence within a particular source of content 104, on a relative importance within a paragraph based on sentence structure and/or grammar patterns, and/or on a frequency of occurrence within multiple sources of content 104 within a limited period of time. The trending term 474 may further be selected based upon a recent appearance of the trending term 474 and/or on a persistence of a trending term 474 over time. The trending term 474 may be identified based on a particular speaker and/or author. The trending term 474 may be selected based on a appearance of a term in conjunction with other trending terms 474.

The trending term 474 may be derived from tagged information accompanying video or photographs. The trending term may also be obtained from text, such as news articles, emails, magazines, blogs, or community based news servers (e.g., Digg®, Yahoo Buzz®, etc.). The trending term may be obtained from electronic speech, such as a recorded meeting, a telephone conversation, a dictated memorandum. The trending term may further be identified based on search requests (e.g., within Google®, Amazon®, Yahoo®, Facebook®, an internal network, etc.). Additional examples of sources of trending terms are described in association with FIG. 5 below.

FIG. 4B illustrates the interpretation module 334 interpreting the trending term 474 (e.g., a descriptive term) when it is received to identify an association parameter 476 (e.g., an associated image, an identity, a dictionary derived meaning, a sound, a movie, a product, a book, etc.). The interpretation module 334 may use internal capturing and/or external capturing to derive a meaning of the trending term 474. The internal capturing may search the sources of content 104 where the trending term 474 was obtained to derive a meaning from context. The meaning may be derived from text, from audio, or from a video context. The internal capturing may acquire a meaning for a particular term that is based on a visual and/or auditory association with the trending term based on a concurrence in timing of the trending term 474 and the display. The internal capturing may also rely on a tag of the sound, text, and/or image.

The external capturing may seek a meaning from external references and media, such as an online reference (e.g., Webster's®, Wikipedia®, etc.) and/or from other media that includes the trending term 474. External capturing may perform a search using external servers to determine a meaning of the trending term 474.

FIG. 4C illustrates the association module 336 algorithmically determining a media attribute 478 associated with the trending term 474 using a computer process (e.g., using the processor 346 and/or the memory 348 of the channel server 342). The media attribute 478 may be a metadata, such as a text tag associated with a video, a file size, and/or a file creation information. The media attribute 478 may also be a visual and/or audio data (e.g., a photograph, a video, an MP3 file, a wave file, etc.).

In an embodiment, a statistical relationship between the related media content and an audience may affect the algorithm used to determine the media attribute 478. For example, a popular show that a trending term is derived from may appeal to a particular audience demographic (e.g., men of a certain age range, women, teenagers, etc.) In an additional embodiment, an association between at least two individuals (e.g., members of a demographic, friends in a social network, viewers with similar interests, etc.) may affect the algorithm that determines a media attribute 478. For example, a media attribute 478 may be chosen based on a friend's selected media attribute, based on a similarity of viewing interests and/or the collective social network of the individuals. The algorithm may thus account for the appropriate demographic and/or viewer relationship when a media attribute 478 is determined.

The association module 336 may use the association parameter 336 to algorithmically determine the media attribute 478. The algorithm used by the association module 336 may consist of a process in which the internal and/or external capturing used to define interpret the meaning of the trending term 474 also is used to identify media characteristics (e.g., an image, a metadata tag, a title, a publication date, an audio data, etc.) that embody the association parameter 376 associated with the trending term 374.

The media attribute 478 may be a product code used by retail sellers of a product. The media attribute 478 may be a visual image of a person, a place, or a thing. The media attribute 478 may be text that is identical to the trending term 474, or it may be related in meaning to the trending term 474. For example, the trending term 474 may relate to a particular type of destination, such as “beach vacations.” The media attribute 478 may be an image of beaches, text referring to “holiday destinations” which may include “beach vacations,” and/or audio that relates to “beach vacations.” The media attribute 478 may be audio that may relate to “beach vacations” may include ocean sounds, and/or music from popular vacation areas in close proximity to beaches.

FIG. 4D illustrates the channel updating module 338 acquiring media 480A-N that includes the media attribute 478A-N to update the created channels 102. The media 480A-N may be stored on the database 344A-N. In another embodiment, the databases 344A-N may be external to the channel creation module 100. The channel updating module 338 may acquire the media 480A-N that contains the media attribute 478A-N, or it may merely provide a source identifier to the created channels 102. The source identifier may allow the media 480A-N to be acquired by a user that wishes to view the created channels 102 at a later time.

FIG. 4E illustrates the created channels 102 being viewed by the interested viewers 108. The acquisition module 340 may acquire the media 480A-N from the sources of content 104 when the created channels 102 are requested for viewing by the interested viewers 108. In another embodiment, the media 480A-N may already include all media information needed to display the created channels 102 to the interested viewers 108.

The acquisition module 340 may acquire information from the sources of content 104 at the time when the channels are to be viewed and/or at some time substantially prior to the time when the channels are to be viewed. The acquisition module 340 may acquire the media 480A-N on an ongoing basis while the channels are viewed, and/or the acquisition module 340 may seek media that may be in sequence to be viewed after several previously acquired media 480A-N have been viewed and/or dismissed by an interested viewer 108. The acquisition module 340 may operate automatically to acquire media 480A-N previously identified and/or obtained by the channel updating module 338. The acquisition module 340 may further acquire media 480A-N based on feedback from the interested viewers 108.

FIG. 5 is an exploded view of the sources of content 504, according to one embodiment. In particular, FIG. 5 illustrates sources of content 504, an electronically converted audio server 552, a precreated feed server 562, the blog server 112, a micro-blog server 564, the news server 108, an online reference server 566, the email server 116, an instant message server 568, a phone and text message server 570, a review server 572, a social networking server 550, the community based news server 114, a cable provider 556, a network storage 558, a media content provider 554, a local storage 560. Sources of content 504 illustrates various servers, storage devices, and content providers that may be automatically searched and accessed by the channel creation module 100 and its subcomponents to generate customized channels.

Sources of content 504 and 104 may be used interchangeably, and may include fewer or additional sources of media content and information. Sources of content 504 may also provide the internal and/or external content to be captured to interpret the trending term 474. In addition, sources of content 504 may be used to determine a media attribute 476 associated with the trending term and provide the media 480 that includes the media attribute 478. The various sources of content 504 illustrated in FIG. 5 are described in greater detail below.

The electronically converted audio server 552 may allow telephone conversations over cell phone networks, traditional phone networks, and internet phones to provide trending terms 474 on which to base a created channel 102. The electronically converted audio may also include voice mail, recorded conversations, and speech from other forms of media, such as online videos, music, and movies.

The precreated feed server 562 (e.g., a web feed, a news feed, etc.) may include published online content relating to news, weather, events or other information. The blog server 112 may provide access to a website that provides entries of commentary, descriptions of events, and/or media that includes video or graphics. The micro-blog server 564 (e.g., Twitter®, Plurk®, Pownce®, Jaiku®, Facebook® updates, etc.) may provide access to brief text updates and/or micromedia posted by a user of a micro-blogging service. The brief text updates may be a limited number of characters, may include photos and/or audio, and may be published online or through mobile media.

The news server 108 may provide access to information published by various news service providers (e.g., ABC®, CNN®, CNET®, Weather.com®, etc.). The online reference server 566 may provide access to online references (e.g., Dictionary.com, Thesaurus.com®, Wikipedia®, etc.). These references and any other source of content 102 may be used by the channel creation module 100 to interpret the trending term 474, to determine an association parameter 476, and to identify media 480 to use in a created channel 102.

The email server 116 (e.g., Gmail®, Outlook®, Yahoo®, Facebook®, etc.) and the instant message server 568 (e.g., Gchat®, Skype® chat, Trillian®, Yahoo® chat, etc.) may provide access to email messages and instant messages. The phone and text message server 570 (e.g., AT&T®, Sprint®, T-Mobile®, Verizon®, etc.) may provide access to text messages, phone calls and/or voicemail.

The review server 572 (e.g., CNET®, RottenTomatoes®, IMDB®, etc.) may provide access to online reviews about current movies, products, events, and other media. The social networking server 550 (e.g., Facebook®, Myspace®, Friendster®, etc.) may provide access to discussions, instant messages, and other user information that may be used to create channels of an interested viewer 108. The community based news server 114 (e.g., Yahoo Buzz®, Digg®, etc.) may provide access to news stories created and/or shared by users that is also evaluated for interest by other users.

The cable provider 556 (e.g., Comcast®, etc.) may provide access to traditional cable media, an established base of users, online content and media 480 provided via cable subscriptions. The cable provider 556 may further provide a mechanism to provide media to interested viewers 108. Similarly, a media content provider (e.g., HBO®, Cinemax®, Disney®, Netflix®, Blockbuster®, etc.) may provide access to media 480 to identify trending terms 474 and association parameters 476 as well as to search for media 480 containing media attributes 478. In addition, media 480, sources of content 104, and contexts for identifying trending terms 474 and association parameters 476 may also be derived from local storage 560 and network storage 558.

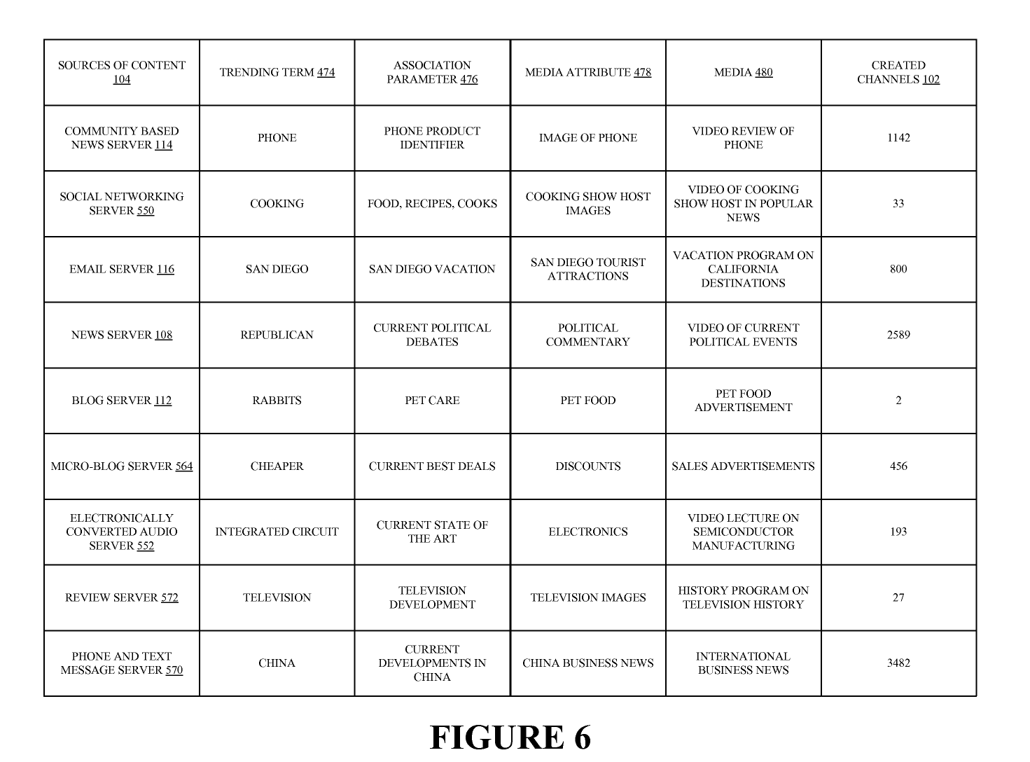

FIG. 6 is a table view illustrating sources of content 104, trending terms 474, and associated information, according to one embodiment. In particular, FIG. 6 illustrates sources of content 104, trending terms 474, association parameters 476, media attributes 478, media 480, and created channels 102, according to one embodiment. The sources of content 104 listed include the community based news server 114, social networking server 550, email server 116, news server 108, blog server 112, micro-blog server 564, electronically converted audio server 552, review server 572, and phone and text message server 570.

FIG. 6 illustrates examples of sources of content 104, trending terms 474, and association parameters 476 that may be associated with the trending terms 474. FIG. 6 further illustrates media attributes 478 that may algorithmically be determined to be associated with the trending term 474 using a computer process, and media 480 that may include the media attribute 478.

For example, a trending term 474 “phone” (e.g., a currently popular model of phone) may be obtained from a community based news server 104 (e.g., Yahoo Buzz®). A “phone product identifier” (e.g., a brand name, a bar code, a manufacturer, etc.) may be interpreted to be associated with the particular model of phone described in the community based news server. The association may be determined using internal capturing of information available from the community based news server 114 and/or from external capturing of information available from external media, such as an online reference server 566 (e.g., Wikipedia®). The media attribute 478 associated with the phone may be an image of the phone, such as a commonly used advertisement image of the phone and/or a news image of the phone. The media 480 that may be acquired that includes the media attribute 478 of the image of the phone may be a video review. A channel, “1142” may be created to display the video review of the phone to a group of interested viewers.

In one embodiment, the created channel 102 may be displayed to a viewer using a cable transmission, a network, a wireless transmission, and/or a local storage medium. The related media content of the created channel 102 may be acquired and stored prior to any viewer's viewing of the channel. Alternatively, the created channel 102 may include a preset sequence of media 480, a limited number of which are acquired prior to viewing. In another embodiment, the channel media 480 are acquired when an interested viewer 108 decides to seek and view the information. The related media content may be acquired from an online media source (e.g., HBO®, a content aggregator, Netflix, etc.), a cable provider (e.g, Comcast), network storage, and/or local storage. In an embodiment, the created channel 102 may be preserved based on a persistence of viewer interest over time.

The development of customized channels based on trending terms 476 may occur in a similar manner for other channels illustrated in FIG. 6. For example, a trending term “cooking” may be obtained from a social networking server (e.g., Facebook®). The term “cooking” may be determined to be associated with association parameters 476 “food”, “recipes”, and “cooks.” Based on the trending term 474 and the association parameter 476, a media attribute 478 may be algorithmically identified to be images of a cooking show host. The algorithm to determine a media attribute 478 may be affected by an association between two or more individuals (e.g., a social network of friends). The algorithm to determine a media attribute 478 may also be affected by a statistical relationship between related media content and an audience (e.g., a social demographic associated with a program, images of a sport, and/or recordings of a performance).

In another embodiment, “San Diego” may be identified as a trending term based on emails obtained from an email server 116. The association parameter 476 may be “San Diego Vacation” based on the context of the email and/or external information related to upcoming San Diego events. The media attribute 478 may be determined to be San Diego tourist attractions, and the media 480 including the media attribute may be a vacation program on California destinations.

“Republican” may be a trending term 474 identified from a news server 108, and the association parameter may be current political debates based on the popularity of politics on the news server 108 as well as in other sources of trending terms (e.g., the blog server, the community based news server 114, etc.). The associated media attribute 478 may be determined to be images and/or audio of political commentary, and the media 580 including political commentary may be a video of current political events.

Other examples are also illustrated in FIG. 6. For example, “rabbits” may be a trending term 474 identified from a blog server 112 and associated with association parameter 476 “pet care.” The media attribute 478 may be “pet food,” and a pet food advertisement may be the media 480 acquired to use with respect to the created channel 102. In another embodiment, “cheaper” may be a trending term 474 identified from a micro-blog server 564 and associated with association parameter 476 “current best deals.” The media attribute 478 may be metadata relating to “discounts,” and sales advertisements may be the media 480 acquired to use with respect to the created channel 102.

Similarly, “integrated circuit” may be a trending term 474 identified from an electronically converted audio server 552 and associated with association parameter 476 “current state of the art.” The media attribute 478 may be “electronics,” and a video lecture on semiconductor manufacturing may be the media 480 acquired to use with respect to the created channel 102. In addition, “television” may be a trending term 474 identified from a review server 572 and associated with association parameter 476 “television development.” The media attribute 478 may be “television images,” and a history program on television history may be the media 480 acquired to use with respect to the created channel 102.

In another example embodiment, “China” may be a trending term 474 identified from a phone and text message server 570 and associated with association parameter 476 “current developments in China.” The media attribute 478 may be “China Business News,” and a program on international business news may be the media 480 acquired to use with respect to the created channel 102.

FIG. 7 is a user interface view illustrating a display of a customized channel, according to one embodiment. Particularly, FIG. 7 illustrates user options 700, a rate option 702, a fast forward option 704, a replay option 706, a search available component channels option 708, a join a social network option 710, a recommended component channels to add 712, Jim's Sports Channel 714, and a Canadian Rabbit Breeding Channel 716, according to one embodiment.

The user options 700 may enable the viewer to customize settings of the channel based on the preference of the viewer. The rate option 702 may enable the viewer to rate the media content presented in the channel. The fast forward option 704 may allow a user to switch to a subsequent media 480 of a predetermined sequence of media 480 content that make up the created channel 102. The replay option 706 may enable the viewer to replay the media content (e.g., video, audio, multimedia, etc.) of the channel.

A search available component channels option 708 may allow a viewer to search for other channels based on text based search, the viewer's viewing history and/or preferences, and/or the viewer's social network. The join a social network option 710 may provide a viewer with an option of becoming associated with a social network. The recommended component channels to add option 712 may suggest other channels to view based on the viewer's interests, viewing behavior, and/or social network. For example, Jim's Sports Channel 714 and a Canadian Rabbit Breeding Channel 716 may be presented simultaneously as active video content and/or as still images as additional content that may be of interest to the viewer, according to one embodiment.

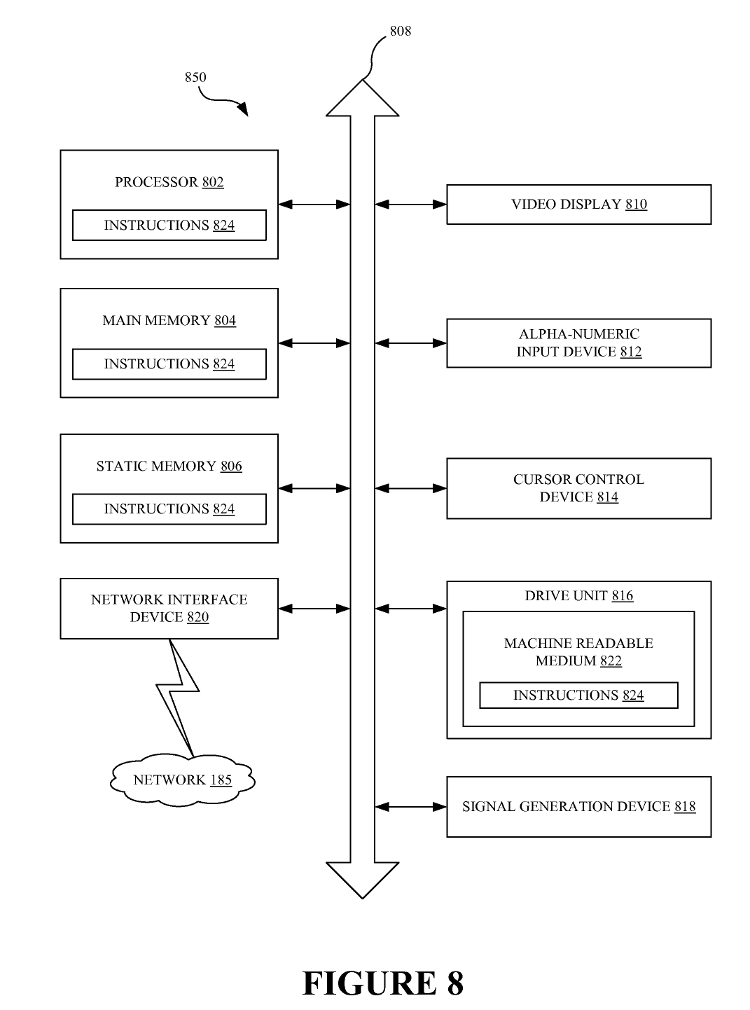

FIG. 8 is a diagrammatic system view of a data processing system in which any of the embodiments disclosed herein may be performed, according to one embodiment. Particularly, the diagrammatic system view 800 of FIG. 8 illustrates a processor 802, a main memory 804, a static memory 806, a bus 808, a video display 810, an alpha-numeric input device 812, a cursor control device 814, a drive unit 816, a signal generation device 818, a network interface device 820, a machine readable medium 822, instructions 824, and a network 185, according to one embodiment.

The diagrammatic system view 800 may indicate a personal computer and/or the data processing system in which one or more operations disclosed herein are performed. The processor 802 may be a microprocessor, a state machine, an application specific integrated circuit, a field programmable gate array, etc. (e.g., Intel® Pentium® processor). The main memory 804 may be a dynamic random access memory and/or a primary memory of a computer system.

The static memory 806 may be a hard drive, a flash drive, and/or other memory information associated with the data processing system. The bus 808 may be an interconnection between various circuits and/or structures of the data processing system. The video display 810 may provide graphical representation of information on the data processing system. The alpha-numeric input device 812 may be a keypad, a keyboard and/or any other input device of text (e.g., a special device to aid the physically handicapped).

The cursor control device 814 may be a pointing device such as a mouse. The drive unit 816 may be the hard drive, a storage system, and/or other longer term storage subsystem. The signal generation device 818 may be a bios and/or a functional operating system of the data processing system. The network interface device 820 may be a device that performs interface functions such as code conversion, protocol conversion and/or buffering required for communication to and from the network 185. The machine readable medium 822 may provide instructions on which any of the methods disclosed herein may be performed. The instructions 824 may provide source code and/or data code to the processor 802 to enable any one or more operations disclosed herein.

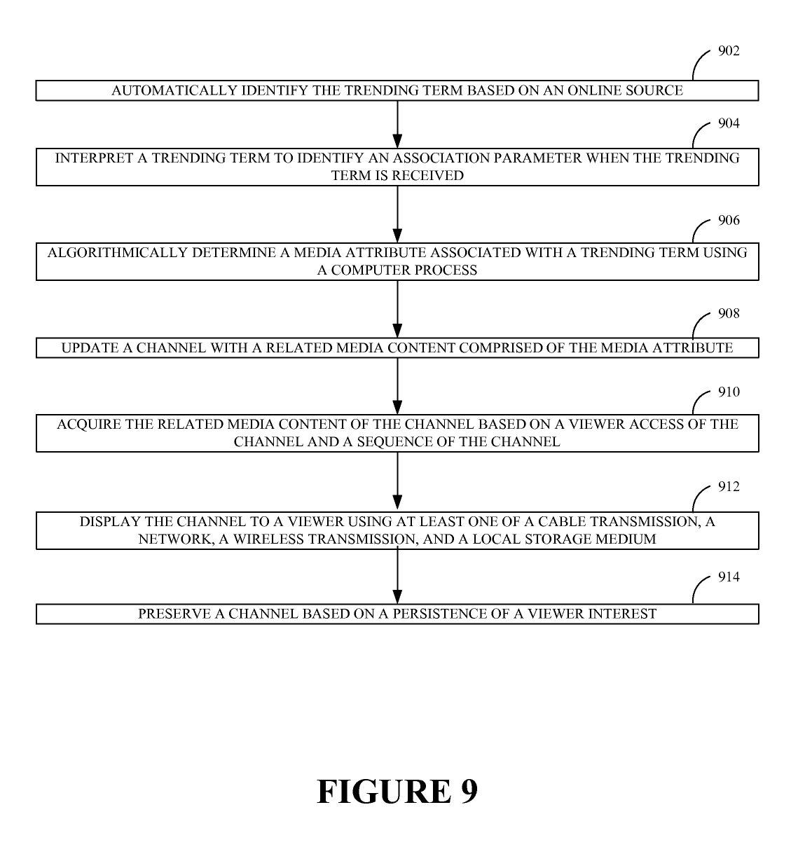

FIG. 9 is a process flow chart that illustrates the creation of a customized channel, according to one embodiment. In operation 902, the trending term 474 may be automatically identified based on an online source. In operation 904, the trending term 474 may be interpreted to identify (e.g., as illustrated in FIG. 2A-D) an association parameter when the trending term is received. In operation 906, the media attribute 478 (e.g., a metadata, a visual data, an audio data, etc.) associated with the trending term may be algorithmically determined using a computer process. In operation 908, the channel 102 may be updated with a related media content that includes the media attribute 478. In operation 910, the related media content of the channel 102 may be acquired based on a viewer access of the channel 102 and a sequence of the channel 102. In operation 912, the channel 102 may be displayed to a viewer using one or more of a cable transmission, a network, a wireless transmission, and a local storage medium. In operation 914, the channel 102 may be preserved based on a persistence of a viewer interest.

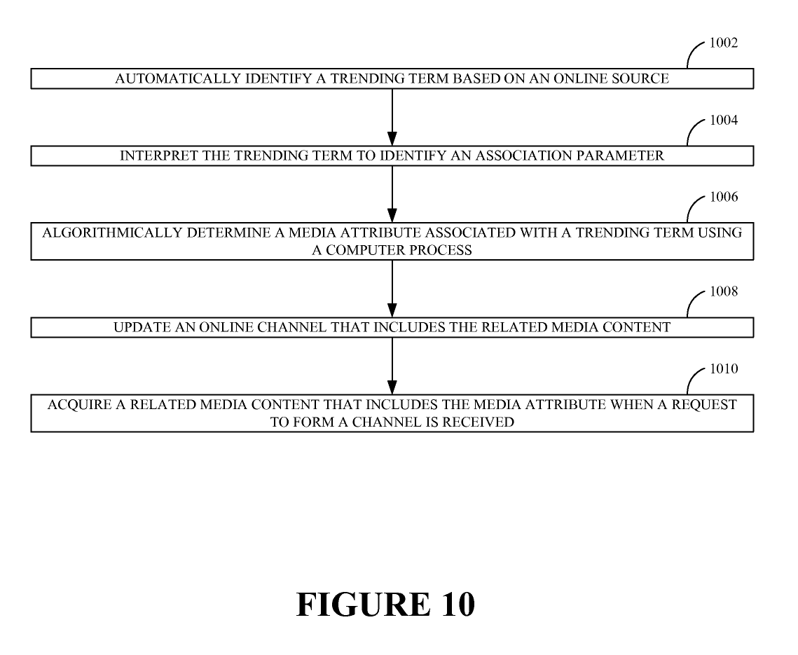

FIG. 10 is a process flow of updating the channel with the acquired media content, according to one embodiment. In operation 1002, the trending term 474 may be automatically identified (e.g., using the identification module 230 of FIG. 2) based on an online source. In operation 1004, the trending term 474 may be interpreted (e.g., using the interpretation module 242 of FIG. 2) to identify an association parameter. In operation 1006, the media attribute 478 associated with the trending term 474 may be algorithmically determined using a computer process. In operation 1008, an online channel that includes the related media content may be updated (e.g., using the channel updating module 252 of FIG. 2). In operation 1010, a related media content that includes the media attribute 478 may be acquired (e.g., using the acquisition module 340 of FIG. 2) when a request to form a channel 102 is received.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

Particularly, the channel creation module 100, the identification module 332, the interpretation module 334, the association module 336, the channel updating module 338, the acquisition module 340 may be enabled using software and/or using transistors, logic gates, and electrical circuits (e.g., application specific integrated ASIC circuitry) such as a channel creation circuit, an identification circuit, an interpretation circuit, an association circuit, a channel updating circuit, and an acquisition circuit, and other circuits.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
interpreting a trending term to identify an association parameter when the trending term is received;
algorithmically determining a media attribute associated with the trending term using a computer process; and
updating a channel with a related media content comprised of the media attribute.

2. The method of claim 1, wherein the media attribute is comprised of at least one of a metadata, a visual data, and an audio data.

3. The method of claim 1, wherein the trending term is interpreted using at least one of internal capturing and external capturing when the trending term is received.

4. The method of claim 1, further comprising displaying the channel to a viewer using at least one of a cable transmission, a network, a wireless transmission, and a local storage medium.

5. The method of claim 1, further comprising acquiring the related media content of the channel based on a viewer access of the channel and a sequence of the channel.

6. The method of claim 5, wherein the related media content is acquired from at least one of an online media source, a cable source, a network storage, and a local storage.

7. The method of claim 1, further comprising preserving the channel based on a persistence of a viewer interest.

8. The method of claim 1, wherein a statistical relationship between the related media content and an audience affects the algorithm used to determine the media attribute.

9. The method of claim 1, wherein an association between at least two individuals affects the algorithm used to determine the media attribute.

10. The method of claim 1, further comprising automatically identifying the trending term based on an online source.

11. The method of claim 10, wherein the trending term is identified using at least one of electronically converted audio, a precreated feed, a blog, a micro-blog, a news site, an online reference, an email, an IM, a text message, a review site, a social networking site, a community based news article site, and a media content provider.

12. A system comprising:
a server comprised of a processor and a memory;
an identification module of the server to automatically identify a trending term using the processor and the memory;
an interpretation module to interpret the trending term to identify an association parameter;
an association module of the server that algorithmically determines a media attribute associated with the trending term when the trending term has been identified;
a channel to be updated using a related media content comprised of the media attribute; and
an acquisition module to acquire the related media content when a request to form the channel is received.

13. The system of claim 12, wherein the trending term is identified using at least one of electronically converted audio, a precreated feed, a blog, a micro-blog, a news site, an online reference, an email, an IM, a text message, a review site, a social networking site, and a media content provider.

14. The system of claim 12, wherein the media attribute is comprised of at least one of a metadata, a visual data, and an audio data.

15. The system of claim 12, wherein the trending term is interpreted using at least one of internal capturing and external capturing when the trending term is received.

16. The system of claim 12, further comprising a display module to display the channel to a viewer using at least one of a website, a cable transmission, a network transmission, a wireless transmission, and a local storage.

17. The system of claim 12, further comprising acquiring the related media content of the channel based on a viewer access of the channel and a sequence of the channel.

18. The system of claim 17, wherein the related media content is acquired from at least one of an online media source, a cable source, a network storage, and a local storage medium.

19. A method comprising:
automatically identifying a trending term based on an online source;
interpreting the trending term to identify an association parameter;
algorithmically determining a media attribute associated with the trending term using a computer process, wherein the trending term is identified using a communication comprised of at least one of electronically converted audio, a precreated feed, a blog, a micro-blog, a news site, an online reference, an email, an IM, a text message, a review site, a social networking site, and a media content provider;
updating an online channel comprised of a related media content; and
acquiring a related media content comprised of the media attribute when a request to form a channel is received, wherein the media attribute is comprised of at least one of a metadata, a visual data, and an audio data.

20. The method of claim 19, wherein a portion of the algorithm that determines a media attribute associated with the trending term interprets the trending term using at least one of internal capturing and external capturing.
